(19) United States
(12) Patent Application Publication
(10) Pub. No.: US 2023/0241923 A1
(43) Pub. Date: Aug. 3, 2023

(54) TIRE AND METHOD FOR USING THE SAME

(71) Applicant: Sumitomo Rubber Industries, Ltd., Kobe-shi (JP)

(72) Inventor: Koki NAGASAWA, Kobe-shi (JP)

(73) Assignee: Sumitomo Rubber Industries, Ltd., Kobe-shi (JP)

(21) Appl. No.: 18/074,041

(22) Filed: Dec. 2, 2022

(30) Foreign Application Priority Data
Jan. 31, 2022 (JP) 2022-013282

(51) Int. Cl. B60C 11/00; B60C 11/24

(52) U.S. Cl. CPC B60C 11/005; B60C 11/24; B60C 2011/0025; B60C 2011/0033

(57) ABSTRACT

A tire includes a tread portion including a ground contact surface, a first rubber layer made of a first cap rubber forming part of the ground contact surface, a second rubber layer made of a second cap rubber disposed radially inwardly of the first rubber layer, and at least one groove portion opening to the ground contact surface. The first cap rubber has a loss tangent tan δ1, and the second cap rubber has a loss tangent tan δ2 greater than the loss tangent tan δ1. The groove portion includes a first indicator in which a bottom of the groove portion locally raises, the first indicator having an outer surface in a tire radial direction. The radially outer surface of the first indicator substantially coincides with a first wear line that is parallel to the ground contact surface and passes through a radially outer surface of the second rubber layer.

### RELATED APPLICATIONS

This application claims the benefit of foreign priority to Japanese Patent Application No. JP2022-013282, filed Jan. 31, 2022, which is incorporated by reference in its entirety.

### FIELD OF THE DISCLOSURE

The present disclosure relates to a tire and a method for using the same.

### BACKGROUND OF THE DISCLOSURE

Patent Document 1 below has proposed a pneumatic tire that is expected to have low rolling resistance and better wet braking performance by specifying the loss tangent of a first cap layer and a second cap layer of the tread.

### PATENT DOCUMENT

### Patent Document 1

Japanese Unexamined Patent Application Publication 2018-002008

### SUMMARY OF THE DISCLOSURE

In general, as tread wear progresses, the volume of the grooves on the tread decreases, resulting in a gradual decrease in wet performance. In particular, the tire of Patent Document 1 tends to further deteriorate wet performance when the second cap layer appears on the ground contact surface.

The smaller the reduction in wet performance due to tread wear, the more desirable it is. It is also desirable that tread wear can be confirmed immediately when the tire is observed.

The present disclosure has been made in view of the above circumstances and has a major object to provide a tire in which deterioration of wet performance due to tread wear is small and the tread wear can be checked immediately, and a method of using the tire capable of further suppressing the deterioration of wet performance.

In one aspect of the present disclosure, a tire includes a tread portion. The tread portion includes a ground contact surface, a first rubber layer made of a first cap rubber that forms at least a part of the ground contact surface, a second rubber layer made of a second cap rubber that is disposed radially inwardly of the first rubber layer, and at least one groove portion opening to the ground contact surface. The first cap rubber has a loss tangent tan δ1, and the second cap rubber has a loss tangent tan δ2 greater than the loss tangent tan δ1. The groove portion includes a first indicator in which a bottom of the groove portion locally raises, the first indicator having an outer surface in a tire radial direction. The radially outer surface of the first indicator substantially coincides with a first wear line that is parallel to the ground contact surface and passes through a radially outer surface of the second rubber layer.

### BRIEF DESCRIPTION OF THE DRAWINGS

FIG. 1 is a tire meridian cross-sectional view of one embodiment of the tire according to the present disclosure;

FIG. 2 is a partial enlarged view of the tread portion of FIG. 1;

FIG. 3 is a partial enlarged perspective view of a first indicator of FIG. 2;

FIG. 4 is an enlarged plan view of the first indicator when the tire is new; and

FIG. 5 is an enlarged plan view of the first indicator when the tread portion is worn out.

### DETAILED DESCRIPTION OF THE DISCLOSURE

One or more embodiments of the present disclosure will be described below with reference to the drawings.

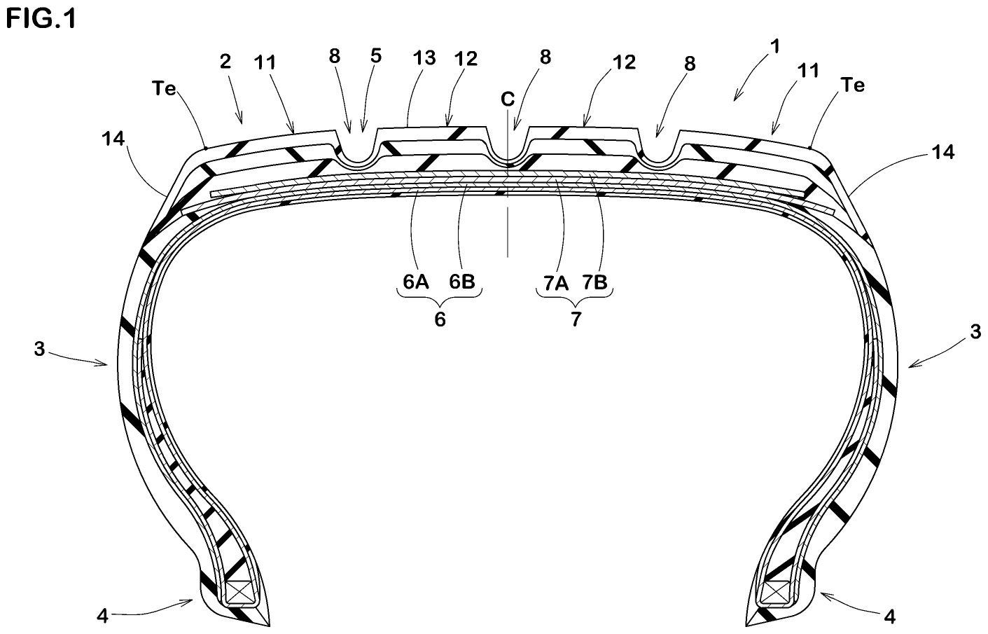

FIG. 1 is a tire meridian cross-sectional view of one embodiment of the tire 1 under a normal state according to the present disclosure. As illustrated in FIG. 1, the present disclosure is preferably applied, for example, to a pneumatic tire for passenger car. However, the present disclosure is not limited to such an aspect, but may be applied to a heavy-duty tire, for example.

As used herein, when a tire is a pneumatic tire based on a standard, the “normal state” is such that the tire 1 is mounted onto a standard wheel rim with a standard pressure but loaded with no tire load. If a tire is not based on the standards, the normal state is a standard state of use according to the purpose of use of the tire and means a state of no load. As used herein, unless otherwise noted, dimensions of portions of the tire are values measured under the normal state.

As used herein, the “standard wheel rim” is a wheel rim officially approved for each tire by standards organizations on which the tire is based, wherein the standard wheel rim is the “standard rim” specified in JATMA, the “Design Rim” in TRA, and the “Measuring Rim” in ETRTO, for example.

As used herein, the “standard pressure” is a standard pressure officially approved for each tire by standards organizations on which the tire is based, wherein the standard pressure is the “maximum air pressure” in JATMA, the maximum pressure given in the “Tire Load Limits at Various Cold Inflation Pressures” table in TRA, and the “Inflation Pressure” in ETRTO, for example.

The tire 1 according to the present embodiment includes tire components, such as a carcass 6 and a tread reinforcing cord layer 7, therein. For these tire components, well known components may be adopted as appropriate.

The carcass 6 extends from one of bead portions 4 to the other one of the bead portions 4, through a pair of sidewall portions 3 and a tread portion 2. In the present embodiment, the carcass 6, for example, is composed of two carcass plies 6A and 6B. The carcass plies 6A and 6B, for example, include carcass cords made of an organic fiber oriented at an angle of from 75 to 90 degrees with respect to the tire circumferential direction.

The tread reinforcing layer 7, for example, includes two reinforcing plies 7A and 7B. The reinforcing plies 7A and 7B, for example, each include a plurality of cords covered with a topping rubber. The cords, for example, are oriented at an angle of from 10 to 45 degrees with respect to the tire circumferential direction. As the cords, various organic fiber cords or steel cords may be used as appropriate, for example.

The tread portion 2 includes a ground contact surface 13 and a pair of buttress surfaces 14. The ground contact surface 13 is the area that is in contact with the ground during normal driving. The buttress surfaces 14 are the outer surfaces located outwardly in the tire axial direction of the ground contact surface 13. The boundaries between the ground contact surface 13 and the respective buttress surfaces 14 are the tread edges Te.

As used herein, the tread edges Te are the axial outermost edges of the ground contact surface 13 of the tire 1 which occurs under the condition such that the tire 1 under the normal state is grounded on a plane with 75% of the standard tire load by zero camber angles.

As used herein, when a tire is a pneumatic tire based on a standard, the “standard tire load” is a tire load officially approved for each tire by the standards organization in which the tire is based, wherein the standard tire load is the “maximum load capacity” in JATMA, the maximum value given in the above-mentioned table in TRA, and the “Load Capacity” in ETRTO, for example. If a tire for which no standards is specified, the “standard tire load” is the maximum load that can be applied to the tire according to the above-mentioned standards.

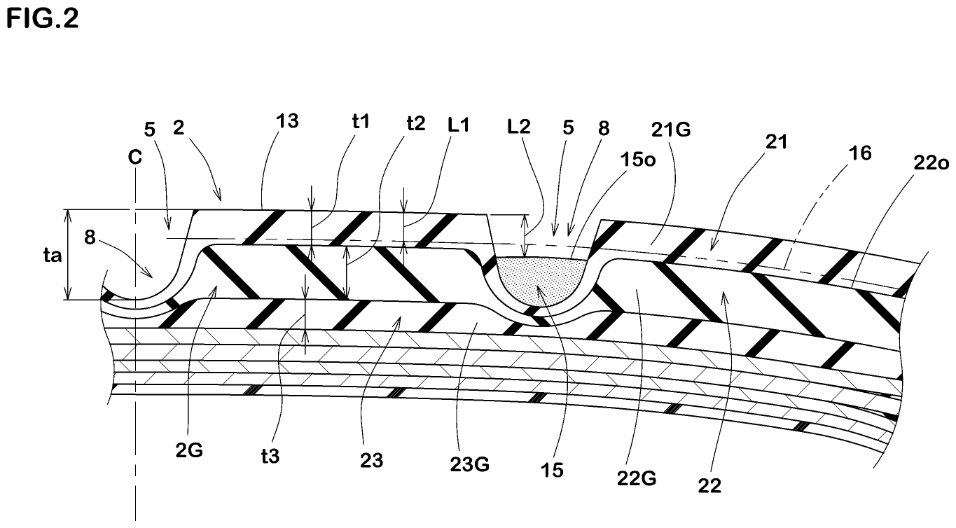

FIG. 2 illustrates a partial enlarged cross-sectional view of the tread portion 2. As illustrated in FIG. 2, the tread portion 2 includes a first rubber layer 21 and a second rubber layer 22. The first rubber layer 21 is made of a first cap rubber 21G and forms at least a part of the ground contact surface 13. In the present embodiment, the first rubber layer 21 also forms a pair of buttress surfaces 14 (shown in FIG. 1). The second rubber layer 22 is made of a second cap rubber 22G and is arranged inwardly in the tire radial direction of the first rubber layer 21. The second rubber layer 22 is in direct contact with the first rubber layer 21.

In general, rubber with a large loss tangent is known to exert a large frictional force on wet road surfaces. Based on such technical matters, in the present disclosure, a loss tangent tan δ2 of the second cap rubber 22G is greater than a loss tangent tan δ1 of the first cap rubber 21G. As used herein, a loss tangent tan δ is a value measured using a dynamic viscoelasticity measuring device (Xplexer series) manufactured by GABO under the following conditions in accordance with the provisions of JIS-K6394.

Initial strain: 5%

Amplitude of dynamic strain: plus/minus 1%

Frequency: 10 Hz

Deformation Mode: Stretch

Measurement temperature: 30 degrees C.

The tread portion 2 further includes at least one groove portion 5 opening to the ground contact surface 13. The groove portion 5 means a cut regardless of the opening width or depth, such as a normal groove provided to improve drainage, a sipe with an opening width of 1.5 mm or less on the outer surface of the tire, and a recess recessed from the ground contact surface 13 locally. The tread portion 2 according to the present embodiment is provided with a plurality of circumferential grooves 8 extending continuously in the tire circumferential direction as the groove portion 5. In addition to the circumferential grooves, the tread portion 2 is preferably provided with one or more lateral grooves extending in the tire axial direction (not illustrated).

As illustrated in FIG. 1, the tread portion 2 includes first land portions 11 and second land portions 12 sectioned by the above-mentioned circumferential grooves 8. The second land portions 12 are arranged closer to the tire equator C than the first land portions 11. In the present embodiment, the tread portion 2 is configured to includes two second land portions 12 arranged closer to the tire equator C and two first land portions 11 arranged to sandwich them. As a result, the tire 1 according to the present embodiment is configured as a so-called 4-rib tire. However, the tire 1 according to the present disclosure is not limited to such a configuration, and the tread portion 2 may be configured as a so-called 5-rib tire in which the tread portion 2 is divided into five land portions by four circumferential grooves 8, for example.

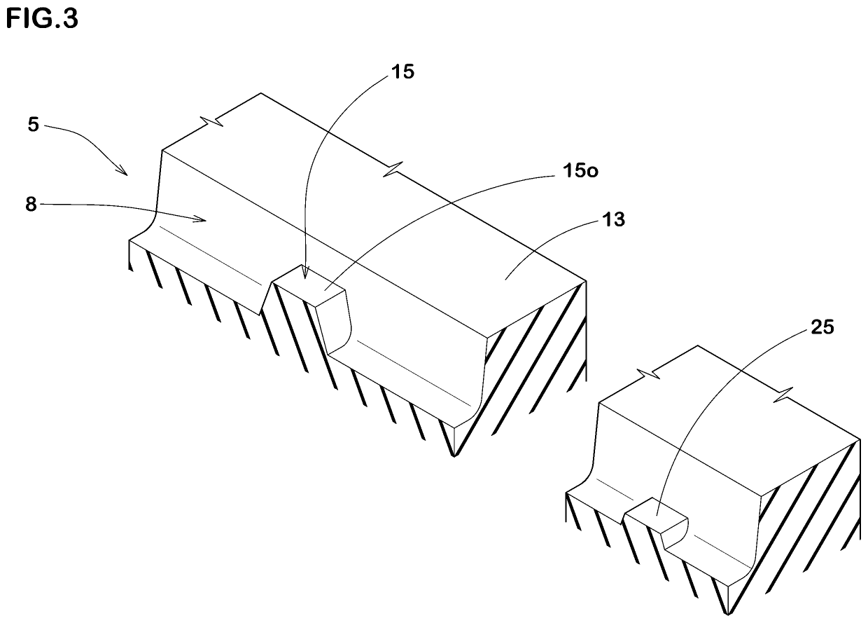

FIG. 3 shows an enlarged perspective view of one of the circumferential grooves 8 as an example of the groove portion 5. As illustrated in FIG. 3, the groove portion 5 includes a first indicator 15 in which a bottom of the groove portion locally raises. Note that in FIG. 3, the boundary between the above-mentioned rubber layers is omitted. The first indicator 15 has a larger height in the tire radial direction than conventional indicators that indicate the wear limit of the tread portion 2 (hereinafter, may be referred to as “second indicator”). The groove portion 5 according to the present embodiment also includes the second indicator 25 (shown in FIG. 3). The second indicator 25, like the first indicator 15, is a portion in which a bottom of the groove portion 5 locally raises. For example, the second indicator 25 may be configured as a “slip sign” having a height of 1.6 mm from the groove bottoms of the circumferential grooves 8.

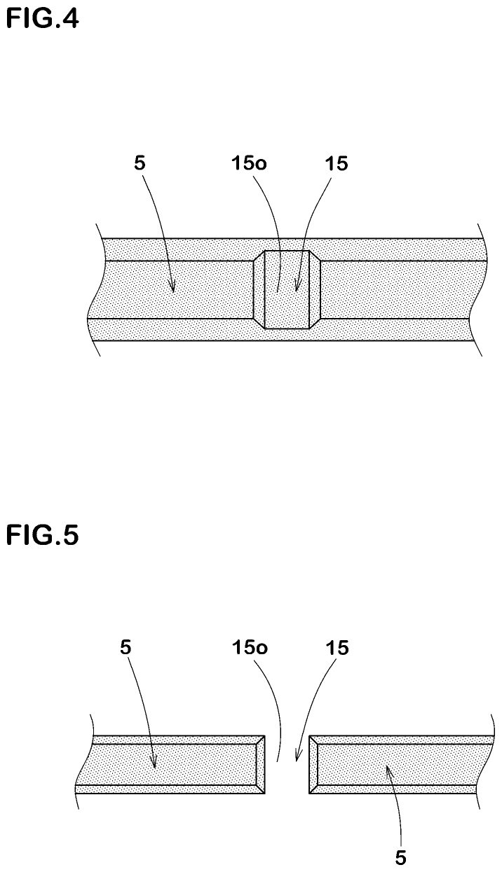

FIG. 4 shows an enlarged plan view of the first indicator 15 when the tire is new, and FIG. 5 shows an enlarged plan view of the first indicator 15 when a radially outer part of the tread rubber is worn out. In FIG. 4 and FIG. 5, the openings of the groove portion 5 is indicated by dots. As illustrated in FIGS. 4 and 5, when the tread portion 2 wears, the outer surface 15o of the first indicator 15 appears on a worn ground contact surface to be continuous to the worn ground contact surface. Thus, the first indicator 15 makes it possible to check whether the tread portion 2 has worn out beyond a certain amount.

As illustrated in FIG. 2, in the present disclosure, when the tire 1 is new, the radially outer surface 15o of the first indicator 15 (dotted in FIG. 2 for ease of understanding) is parallel to the ground contact surface 13 and substantially coincides with a first wear line 16 that passes through a radially outer surface of the second rubber layer 22. Note that the first wear line 16 overlaps the outer surface of the second rubber layer 22, but in FIG. 2 the first wear line 16 is shown as a two-pointed line passing slightly above the outer surface 22o in the tire radial direction of the second rubber layer 22. By adopting the above configuration, the tire 1 according to the present disclosure has little deterioration in wet performance due to wear of the tread portion 2, and wear of the tread portion 2 can be checked immediately. The reason is that when the wear of the tread portion 2 progresses, the second rubber layer 22, which can be expected to have high wet grip, is exposed and suppresses the deterioration of wet performance. Also, the wear can be checked by the appearance of the outer surface 15o of the first indicator 15 in the tire radial direction on the ground contact surface 13 (shown in FIG. 5).

On the other hand, with conventional tires, as tread wear progresses, a worn ground contact surface 13 tends to become flat, and wet performance (especially hydroplaning resistance performance) tends to decrease. In order to deal with such problems, the tire 1 according to the present disclosure has the above-described configuration, so that the above-described tendency can be alleviated by the following method of using the tire 1. The method of using the tire 1 includes running the tire 1 under a first standard internal pressure until the first indicator 15 appears on a worn ground contact surface, and running the tire 1 under a second reference internal pressure greater than the first reference internal pressure after the outer surface 15o of the first indicator 15 appears on the worn ground contact surface.

In such a method of using the tire 1 of the present disclosure, when the wear of the tread portion 2 progresses and the ground contact surface becomes flat, the internal pressure of the tire 1 can be increased to bring the ground contact surface 13 to an appropriate round shape, thus maintaining the hydroplaning resistance performance. In this method, the first standard internal pressure is the internal pressure that is applied to the tire 1 under the normal state of use, for example, the standard pressure mentioned above is adopted. In order to maintain the balance of various performances of the tire, the second standard internal pressure is preferably equal to or less than 120% of the first standard internal pressure.

In order to make it easier for users of the tire 1 to identify the position of the first indicator 15, at least one of the buttress surfaces 14 preferably includes a mark indicating the presence of the first indicator 15 at the same position in the tire circumferential direction as the first indicator 15.

Hereinafter, a more detailed configuration of the present embodiment will be described. Note that each configuration described below shows a specific aspect of the present embodiment. Thus, the present disclosure can exert the above-mentioned effects even if the tire does not include the configuration described below. Further, if any one of the configurations described below is applied independently to the tire of the present disclosure having the above-mentioned characteristics, the performance improvement according to each additional configuration can be expected. Furthermore, when some of the configurations described below are applied in combination, it is expected that the performance of the additional configurations will be improved.

As illustrated in FIG. 2, “the radially outer surface 15o of the first indicator 15 substantially coincides with the first wear line 16” shall include, at a minimum, an aspect where a tire radial distance L2 from the ground contact surface 13 to the outer surface 15o of the first indicator 15 is 90% to 110% of a tire radial distance L1 from the ground contact surface 13 to the first wear line 16. In FIG. 2, the above distances L1 and L2 are shown slightly differently, but in some preferred embodiments they are identical with each other.

The first cap rubber 21G has a loss tangent tan δ1 preferably equal to or more than 0.13, more preferably equal to or more than 0.15, still further preferably equal to or more than 0.18, but preferably equal to or less than 0.29, more preferably equal to or less than 0.25, still further preferably equal to or less than 0.22. Such a first cap rubber 21G, at the beginning of use, can exert well-balanced steering stability on dry roads (hereinafter simply referred to as “steering stability”) and wet performance.

To improve steering stability and wet performance when the tread portion 2 wears, the loss tangent tan δ2 of the second cap rubber 22G is preferably equal to or more than 0.20, more preferably equal to or more than 0.25, still further preferably equal to or more than 0.28, but preferably equal to or less than 0.40, more preferably equal to or less than 0.35, still further preferably equal to or less than 0.32.

In some preferred embodiments, the tread portion 2 may further include a third rubber layer 23 made of a base rubber 23G that is disposed inwardly in the tire radial direction of the second rubber layer 22. Preferably, the base rubber 23G has a loss tangent tan δb smaller than the loss tangent tan δ1. Specifically, the loss tangent tam % is equal to or less than 0.12. The third rubber layer 23, which consists of the base rubber 23G, can help to suppress excessive heat generation in the tread portion 2.

The tread rubber 2G according to the present embodiment consists of only the first rubber layer 21, the second rubber layer 22 and the third rubber layer 23 described above at least in the area that constitutes the ground contact surface 13, and no rubber layers other than these are provided. However, the present disclosure is not limited to such an embodiment, and other rubber layers may be arranged as appropriate. The first rubber layer 21, the second rubber layer 22 and the third rubber layer 23 according to the present embodiment extend to have a substantially constant thickness on the inner side of the ground contact surface 13 in the tire radial direction except around the circumferential grooves 8.

In the present embodiment, a thickness t1 of the first rubber layer 21 is preferably in a range from 30% to 70%, more preferably from 40% to 60%, of an effective tread thickness ta. As a result, when the wear of the tread portion 2 progresses moderately, the second cap rubber 22G, which can be expected to have high wet grip, is exposed, and wet performance can be effectively maintained. Note that the effective tread thickness ta means the thickness of the tread rubber 2G from the ground contact surface 13 to the bottom of the groove portion 5 (e.g., circumferential groove 8).

From the viewpoint of reliably maintaining wet performance, it is preferable that the second rubber layer 22 constitutes the ground contact surface 13 even when the tread rubber 2G is worn out to the limit. In other words, when the tread portion 2 wears beyond the second wear line, which is the wear limit, and the radially outer surface of the second indicator 25 appears on a worn ground contact surface, the second rubber layer 22 preferably constitutes the worn ground contact surface. In some more preferred embodiments, the inner surface of the second rubber layer 22 in the tire radial direction is located inwardly in the tire radial direction of the groove bottoms of the circumferential grooves 8. Thus, wet performance can be maintained for sure.

A thickness t2 of the second rubber layer 22 is preferably in a range from 50% to 70% of the effective tread thickness ta. This makes it possible to obtain the above effects while maintaining the durability of the tread portion 2.

A thickness t3 of the third rubber layer 23 is determined variously so that the first rubber layer 21 and the second rubber layer 22 can have the configuration described above. Preferably, the thickness t3 is in a range from 10% to 30% of the effective tread thickness ta. As a result, it is possible to improve fuel efficiency performance while exhibiting the above-mentioned effects.

While the particularly preferable embodiments of the tire in accordance with the present disclosure have been described in detail, the present disclosure is not limited to the illustrated embodiments, but can be modified and carried out in various aspects within the scope of the disclosure.

### ADDITIONAL NOTES

The present disclosure includes the following aspects.

### [Note 1]

A tire comprising:
a tread portion, wherein
the tread portion comprises
   a ground contact surface,
   a first rubber layer made of a first cap rubber that forms at least a part of the ground contact surface,
   a second rubber layer made of a second cap rubber that is disposed radially inwardly of the first rubber layer, and
   at least one groove portion opening to the ground contact surface,
the first cap rubber has a loss tangent tan δ1,
the second cap rubber has a loss tangent tan δ2 greater than the loss tangent tan δ1,
the groove portion comprises a first indicator in which a bottom of the groove portion locally raises, the first indicator having an outer surface in a tire radial direction, and
the radially outer surface of the first indicator substantially coincides with a first wear line that is parallel to the ground contact surface and passes through a radially outer surface of the second rubber layer.

### [Note 2]

The tire according to note 1,
the tread portion further comprising a third rubber layer made of a base rubber that is disposed inwardly in the tire radial direction of the second rubber layer, wherein
the base rubber has a loss tangent tan δb smaller than the loss tangent tan δ1.

### [Note 3]

The tire according to note 1 or 2, wherein
a distance in the tire radial direction from the ground contact surface to the outer surface of the first indicator is in a range from 90% to 110% of a distance in the tire radial direction from the ground contact surface to the first wear line.

### [Note 4]

The tire according to any one of notes 1 to 3,
the tread portion further comprising a tread edge and a buttress surface extending outwardly in a tire axial direction from the tread edge, wherein
the buttress surface is provided with a mark indicating the presence of the first indicator at a same position in a tire circumferential direction as the first indicator.

### [Note 5]

The tire according to any one of notes 1 to 4, wherein
the groove portion is a circumferential groove that extends continuously in a tire circumferential direction.

### [Note 6]

The tire according to any one of notes 1 to 5, wherein
the groove portion is a sipe having an opening width equal to or less than 1.5 mm at the ground contact surface.

### [Note 7]

The tire according to any one of notes 1 to 6,
the groove portion further comprising a second indicator in which a bottom of the groove portion locally raises, the second indicator having an outer surface in the tire radial direction, wherein
the radially outer surface of the second indicator substantially coincides with a second wear line that is a wear limit of the tread portion.

### [Note 8]

A method of using the tire according to any one of notes 1 to 7, the method comprising:
running the tire under a first reference internal pressure until the first indicator appears on a worn ground contact surface; and
running the tire under a second reference internal pressure greater than the first reference internal pressure after the outer surface of the first indicator appears on the worn ground contact surface.

### [Note 9]

The method according to note 8, wherein
the second reference internal pressure is equal to or less than 120% of the first reference internal pressure.

1. A tire comprising:
a tread portion, wherein
the tread portion comprises
a ground contact surface,
a first rubber layer made of a first cap rubber that forms at least a part of the ground contact surface,
a second rubber layer made of a second cap rubber that is disposed radially inwardly of the first rubber layer, and
at least one groove portion opening to the ground contact surface,
the first cap rubber has a loss tangent tan δ1,
the second cap rubber has a loss tangent tan δ2 greater than the loss tangent tan δ1,
the groove portion comprises a first indicator in which a bottom of the groove portion locally raises, the first indicator having an outer surface in a tire radial direction, and
the radially outer surface of the first indicator substantially coincides with a first wear line that is parallel to the ground contact surface and passes through a radially outer surface of the second rubber layer.

2. The tire according to claim 1,
the tread portion further comprising a third rubber layer made of a base rubber that is disposed inwardly in the tire radial direction of the second rubber layer, wherein
the base rubber has a loss tangent tan δb smaller than the loss tangent tan δ1.

3. The tire according to claim 1, wherein
a distance in the tire radial direction from the ground contact surface to the outer surface of the first indicator is in a range from 90% to 110% of a distance in the tire radial direction from the ground contact surface to the first wear line.

4. The tire according to claim 1,
the tread portion further comprising a tread edge and a buttress surface extending outwardly in a tire axial direction from the tread edge, wherein
the buttress surface is provided with a mark indicating the presence of the first indicator at a same position in a tire circumferential direction as the first indicator.

5. The tire according to claim 1, wherein
the groove portion is a circumferential groove that extends continuously in a tire circumferential direction.

6. The tire according to claim 1, wherein
the groove portion is a sipe having an opening width equal to or less than 1.5 mm at the ground contact surface.

7. The tire according to claim 1,
the groove portion further comprising a second indicator in which a bottom of the groove portion locally raises, the second indicator having an outer surface in the tire radial direction, wherein
the radially outer surface of the second indicator substantially coincides with a second wear line that is a wear limit of the tread portion.

8. A method of using the tire according to claim 1, the method comprising:
running the tire under a first reference internal pressure until the first indicator appears on a worn ground contact surface; and
running the tire under a second reference internal pressure greater than the first reference internal pressure after the outer surface of the first indicator appears on the worn ground contact surface.

9. The method according to claim 8, wherein
the second reference internal pressure is equal to or less than 120% of the first reference internal pressure.

10. The tire according to claim 1, wherein
the loss tangent tan δ1 is in a range from 0.13 to 0.29, and the loss tangent tan δ2 is in a range from 0.20 to 0.40.

11. The tire according to claim 10, wherein
the tread portion further comprising a third rubber layer made of a base rubber that is disposed inwardly in the tire radial direction of the second rubber layer, wherein
the base rubber has a loss tangent tan δb equal to or less than 0.12.

12. The tire according to claim 11,
the tread portion further comprising a tread reinforcing cord layer, wherein a portion of the tread portion from the ground contact surface to a radially outermost surface of the tread reinforcing cord layer consists of the first rubber layer, the second rubber layer and the third rubber layer.

13. The tire according to claim 11, wherein
the first rubber layer has a substantially constant thickness on an inner side in the tire radial direction of the ground contact surface except around the groove portion.

14. The tire according to claim 13, wherein
the second rubber layer has a substantially constant thickness on an inner side in the tire radial direction of the ground contact surface except around the groove portion.

15. The tire according to claim 14, wherein
the third rubber layer has a substantially constant thickness on an inner side in the tire radial direction of the ground contact surface except around the groove portion.

16. The tire according to claim 11, wherein a thickness t1 of the first rubber layer is in a range from 30% to 70% of an effective tread thickness.

17. The tire according to claim 11, wherein a thickness t2 of the second rubber layer is in a range from 50% to 70% of an effective tread thickness.

18. The tire according to claim 16, wherein a thickness t3 of the third rubber layer is in a range from 10% to 30% of an effective tread thickness.
